(19) United States
(12) Patent Application Publication
(10) Pub. No.: US 2003/0086006 A1
(43) Pub. Date: May 8, 2003

(54) Image capturing apparatus and a replacement unit

(75) Inventor: Atsushi Misawa, Saitama (JP)

Correspondence Address: SUGHRUE MION. PLLC, 2100 Pennsylvania Avenue, NW, Washington, DC, 20037-3213, US

(73) Assignee: FUJI PHOTO FILM CO., LTD.

(21) Appl. No.: 10/273,369

(22) Filed: Oct. 18, 2002

(30) Foreign Application Priority Data
Oct. 18, 2001 (JP) 2001-321034

(51) Int. Cl. G03B 17/48; H04N 5/225

(52) U.S. Cl. 348/231.99; 396/429; 348/372; 348/231.1

(57) ABSTRACT

An image capturing apparatus includes a main unit including an optical unit for acquiring an image of an object, and a photographing unit for photographing the image acquired by the optical unit as image data by optical-to-electronic conversion; and a replacement unit including an image recording unit for storing the image data photographed by the photographing unit, and a number information storing unit for storing information specifying a number of images stored in said image recording unit, wherein the replacement unit is detachably mounted on the main unit.

This patent application claims priority from a Japanese patent application No. 2001-321034 filed on Oct. 18, 2001, the contents of which are incorporated herein by reference.

### BACKGROUND OF THE INVENTION

1. Field of the Invention

The present invention relates to an image capturing apparatus and a replacement unit. More uniticularly, the present invention relates to an image capturing apparatus and a replacement unit which record the number of photographed images.

2. Description of the Related Art

There has been known a system and an image capturing apparatus for developing or printing image data by selling a whole photographing apparatus and then taking back the image data as disclosed, for example, in Unexamined Japanese Patent Application Publications Nos. 2001-195465, 2000-115512, 1998-171027 and 1998-78620.

However, since the elements, which are used for controlling the limit number of images or communicating with external devices, or need to be exchanged, are embedded inside the body of the image capturing apparatus, it is inconvenient to reset the limit number of images, to replace the element or to communicate with the elements. Therefore, there has been a problem that it is impossible to sell or lend the image capturing apparatus in a flexible way or for a user's convenience.

### SUMMARY OF THE INVENTION

Therefore, it is an object of the present invention to provide an image capturing apparatus and are placement unit therefor, which are capable of overcoming the above drawbacks accompanying the conventional art. The above and other objects can be achieved by combinations described in the independent claims. The dependent claims define further advantageous and exemplary combinations of the present invention.

According to the first aspect of the present invention, an image capturing apparatus includes a main unit including an optical unit for acquiring an image of an object, and a photographing unit for photographing the image acquired by the optical unit as image data by optical-to-electronic conversion; and a replacement unit including an image recording unit for storing the image data photographed by the photographing unit, and a number information storing unit for storing information specifying a number of images stored in the image recording unit, wherein the replacement unit is detachably mounted on the main unit.

There placement unit may further include a battery for driving the main unit.

The replacement unit may further include a convex or concave portion in order for a user to grasp the image capturing apparatus easily.

The image capturing apparatus may further include a setting unit for storing a predetermined possible storage number in a range of one (1) to a number of storable images determined by a capacity of the image recording unit; and an image reception determining unit for refusing to store the image data in the image recording unit in case that a number specified by number specifying information stored in the number information storing unit is not smaller than the possible storage number stored in the setting unit, and permitting to store the image data in the image recording unit in case that the specified number is smaller than the possible storage number.

The number information storing unit may store key information of which the number is the same with the possible storage number, and change the key information into a format indicating use-ending whenever the photographing unit outputs the image data to the image recording unit.

The image capturing apparatus may further includes a battery for driving the main unit; a setting unit for storing a predetermined possible storage number in a range of one (1) to a number of storable images determined by a capacity of the image recording unit; and a power supply determining unit for stopping supplying power from the battery in case a number specified by number specifying information stored in the number information storing unit is not smaller than the possible storage number.

According to a second aspect of the present invention, a replacement unit of an image capturing apparatus, wherein the replacement unit is detachably mounted on a main unit including an optical unit for acquiring an image of an object, and a photographing unit for photographing the image acquired by the optical unit as image data by optical-to-electronic conversion, includes a replacement unit including an image recording unit for storing the image data photographed by the photographing unit; a number information storing unit for storing information specifying a number of images stored in the image recording unit; a battery for driving the main unit.

The summary of the invention does not necessarily describe all necessary features of the present invention. The present invention may also be a sub-combination of the features described above. The above and other features and advantages of the present invention will become more apparent from the following description of the embodiments taken in conjunction with the accompanying drawings.

### BRIEF DESCRIPTION OF THE DRAWINGS

FIG. 1 is a schematic diagram of an application configuration according to an embodiment of the present invention.

FIG. 2 shows external views of a digital camera according to an embodiment of the present invention.

FIG. 3 shows junction area of a main unit and a replacement unit according to an embodiment of the present invention.

FIG. 4 shows a functional block diagram of an image capturing apparatus according to an embodiment of the present invention.

FIG. 5 shows a functional block diagram of a main unit according to an embodiment of the present invention.

FIG. 6 shows a functional block diagram of a replacement unit according to an embodiment of the present invention.

FIG. 7 is a flow chart showing a process for recording photographed image data on an image recording unit.

FIG. 8 shows a functional block diagram of a replacement unit according to a second embodiment of the present invention.

FIG. 9 is a flow chart showing a process for recording photographed image data on an image recording unit according to a second embodiment of the present invention.

FIG. 10 shows another example of information which specifies the number of image data stored in a number information storing unit according to a first embodiment of the present invention.

FIG. 11 shows a hardware configuration of an image capturing apparatus, e.g. a digital camera, according to an embodiment of the present invention.

### DETAILED DESCRIPTION OF THE INVENTION

The invention will now be described based on the preferred embodiments, which do not intend to limit the scope of the present invention, but exemplify the invention. All of the features and the combinations thereof described in the embodiment are not necessarily essential to the invention.

First Embodiment

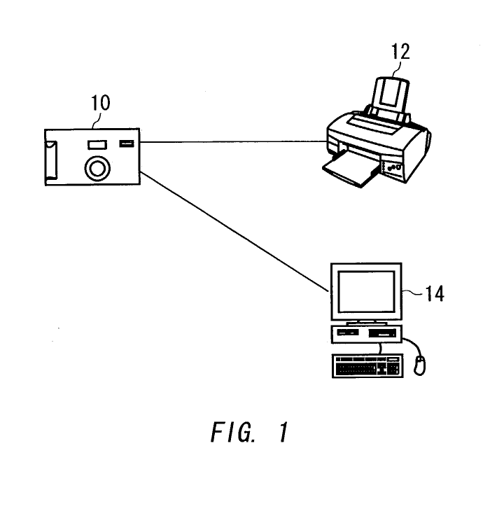

FIG. 1 is a schematic diagram showing a schematic view of an entire system according to an embodiment of the present invention. A digital camera 10 is an example of an image capturing apparatus according to the present invention.

The digital camera 10 captures an object as image data and output the image data. For example, the digital camera 10 outputs the image data to a printer 12 or an image processing device 14. The printer 12 or the image processing device 14 outputs the received image data in an appropriate data format in response to a user's request. For example, the printer 12 prints out the image data on a paper. Or, the image processing device 14 transforms the image data into data of a predetermined electronic data format, or outputs it to a magnetic recording medium.

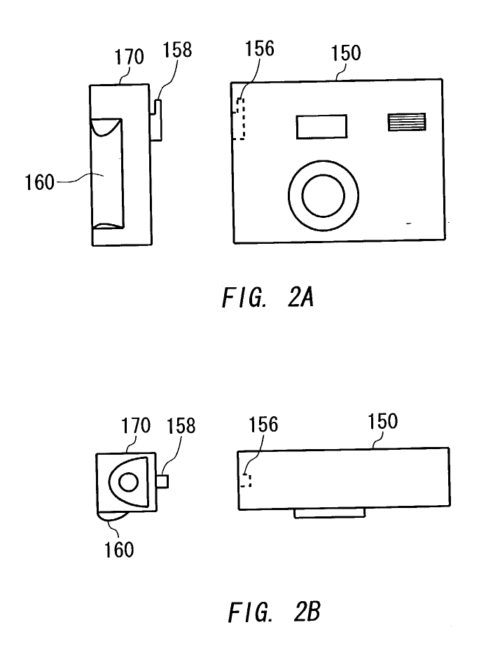

FIG. 2 shows external views of the digital camera 10 according to an embodiment of the present invention. FIG. 2A shows front views of a main unit 150 and a replacement unit 170 included in the digital camera 10. FIG. 2B shows plane views of the main unit 150 and the replacement unit 170 included in the digital camera 10. As it is apparent from FIG. 2, the digital camera 10, an image capturing apparatus, is formed by mounting the replacement unit 170 on the main unit 150. That is to say, the replacement unit 170 forms a portion of the external housing of the digital camera 10. The main unit 150 includes a main unit mounting member 156. The replacement unit 170 is detachably mounted by a replacement unit attaching/detaching member 158. The replacement unit 170 further includes a grip 160 in order for a user to grasp the image capturing apparatus easily. The grip 160 is an example of a convex portion according to an embodiment of the present invention. That is, the grip 160 is a convex portion in order for a user to grasp the digital camera 10 easily. By this, a user can handle the digital camera 10 in more stable with grasping it in her hand. In addition, the grip 160 is a convex portion according to the present embodiment, but it may be formed to be a concave portion instead of a convex portion in order for a user to grasp the digital camera 10 easily with putting her finger(s) inside the concave portion, according to another embodiment of the present invention.

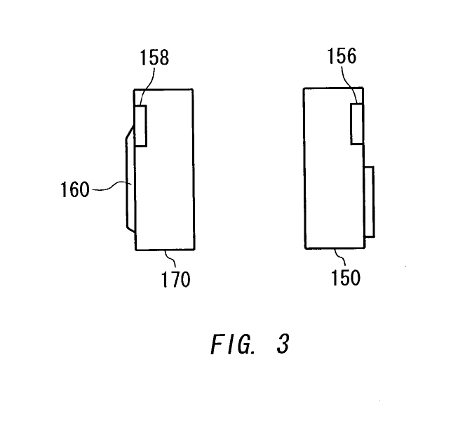

FIG. 3 shows junction area of the main unit 150 and the replacement unit 170 according to an embodiment of the present invention. The main unit attaching/detaching member 156 and the replacement unit attaching/detaching member 158 are engaged with each other, so that the digital camera 10 gets unified to have enough strength to be handled as a single case. For example, the main unit attaching/detaching member 156 having a convex portion is engaged with a concave portion of the replacement unit attaching/detaching member 158. Further, the main unit attaching/detaching member 156 and the replacement unit attaching/detaching member 158 respectively have electrodes (not shown) which may be couple to one another. The image data is outputted from the main unit 150 to the replacement unit 170 via the electrodes. Further, the main unit attaching/detaching member 156 and the replacement unit attaching/detaching member 158 may also have electrodes for supplying power to the main unit 150 from the replacement unit 170.

Further, the replacement unit attaching/detaching member 158 may also be detachably mounted on a device of an outputting place when the image data is outputted. That is to say, the replacement unit 170 outputs image data to the printer 12 and/or the image processing device 14 via the replacement unit attaching/detaching member 158. In addition, the image data may be outputted via a contact or a terminal other than the replacement unit attaching/detaching member 158. For example, a general connector, such as a USB or an RS-232C connector, may be available, but the present invention is limited to the above described ones.

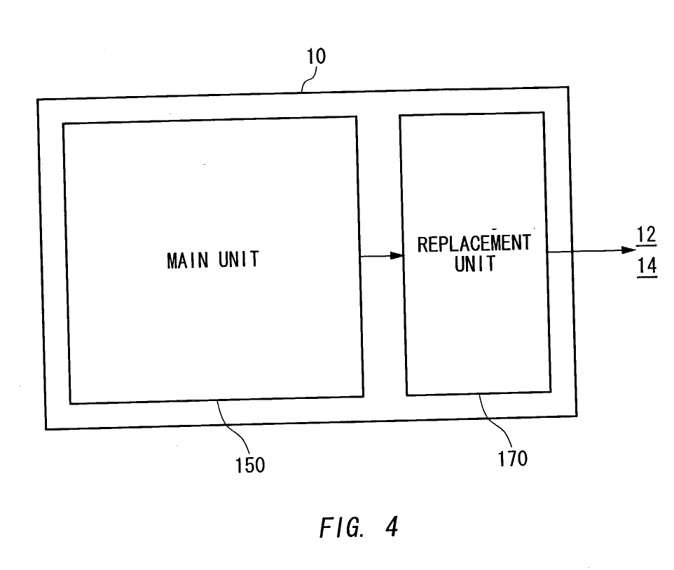

FIG. 4 shows a functional block diagram of the digital camera 10, an example of an image capturing apparatus, according to an embodiment of the present invention. The digital camera 10 includes the main unit 150 and the replacement unit 170. The main unit 150 outputs images taken by a user to the replacement unit 170 as electronic image data. The replacement unit 170 stores the received image data with an upper limit capacity established by an administrator, and outputs the received image data to the printer 12 or the image processing device 14. Herein, the administrator is a person who sells, administers or maintains the main unit 150 and/or the replacement unit 170. A film developing laboratory or a camera manufacturer may be an example of the administrator of the present invention.

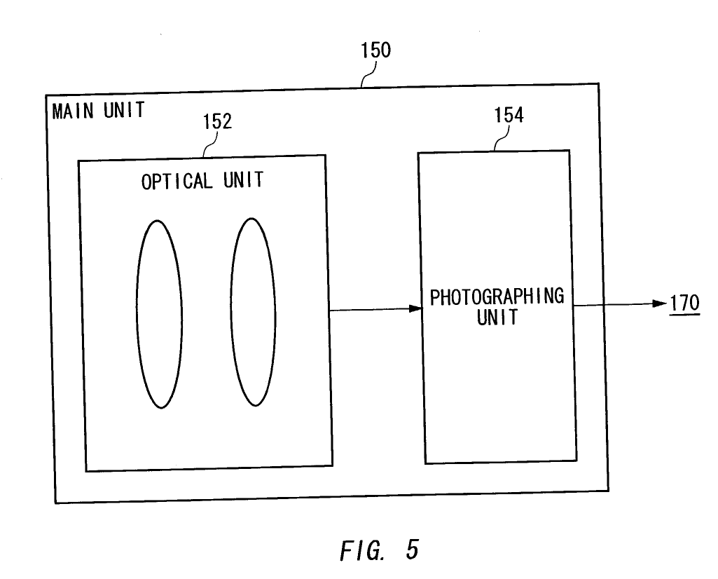

FIG. 5 shows a functional block diagram of the main unit 150 according to an embodiment of the present invention. The main unit 150 includes an optical unit 152 and a photographing unit 154. The optical unit 152 acquires an image and sends the acquired image to the photographing unit 154. The photographing unit 154 photographs the image sent from the optical unit 152 as image data by an optical-to-electronic conversion, and outputs the image data to the replacement unit 170.

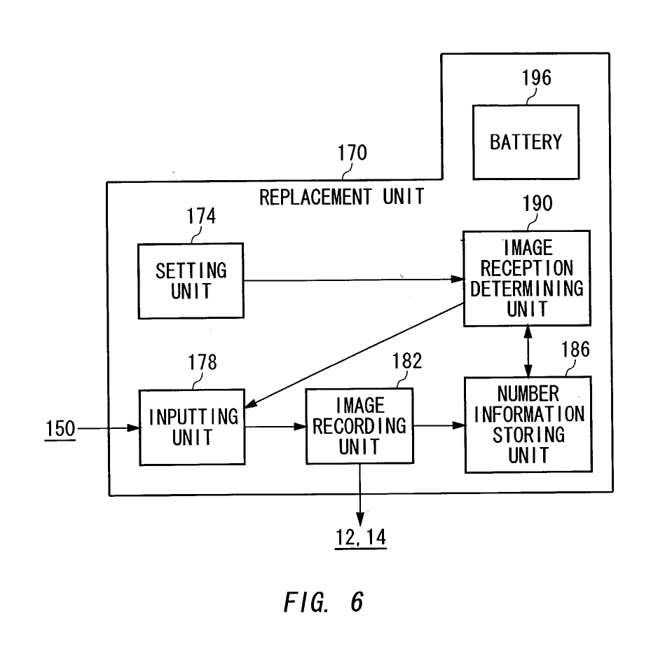

FIG. 6 shows a functional block diagram of the replacement unit 170 according to an embodiment of the present invention. The replacement unit 170 includes a setting unit 174, an inputting unit 178, an image recording unit 182, a number information storing unit 186, an image reception determining unit 190 and a battery 196.

The setting unit 174 stores a possible storage number which indicates how many image data can be stored in the image recording unit 182 as the number of images predetermined by a user. Here, the possible storage number is a value in the range of one (1) to the number of storable images determined by the capacity of the image recording unit 182.

The inputting unit 178 receives photographed image data from the main unit 150, and outputs the received image data to the image recording unit 182 in case the image reception determining unit 190 allows the image data to be received.

The image recording unit 182 outputs image data outputted from the inputting unit 178 to the printer 12 or the image processing device 14. Whenever the image data is received from the inputting unit 178, the image recording unit 182 notifies the number information storing unit 186 that the image data is received.

The number information storing unit 186 stores number specifying information which specifies the number of images stored in the image recording unit 182. The number information storing unit 186 updates the number specifying information to increase the number of images by the number of newly stored images in response to the notification from the image recording unit 182.

The image reception determining unit 190 compares the number specifying information stored in the number information storing unit 186 with the possible storage number stored in the setting unit 174, and outputs control information, to the inputting unit 178, which indicates a permission to receive the image data in case the number specified by the number specifying information is smaller than the possible storage number. In this case, the inputting unit 178 outputs the image data to the image recording unit 182. In case the number specified by the number specifying information is not smaller than the possible storage number, the image reception determining unit 190 outputs control information, to the imputing unit 178, which indicates a refusal to receive the image data. In this case, the inputting unit 178 does not outputs the image data to the image recording unit 182. By this, an administrator may freely set up an upper limit of the number of storable images within the capacity limit of the image recording unit 182. For example, the administrator restricts the number of storable images according to a contract deposit of, for example, a contract for lending the replacement unit 170, or increase conveniences of common utilization.

The replacement unit 170 may further includes a battery 196. The battery 196 supplies power to the main unit 150. Moreover, since the battery 196 is a primary source of weight of the image capturing apparatus as a whole and the replacement unit 170 includes the grip 160 which makes the image capturing apparatus easily carried by a user, the user handles it in stable with sustaining the image capturing apparatus at around the centroid.

Moreover, the user convenience can be increased by arranging elements of high possibilities of exchange or detachment in the replacement unit 170 which includes the image recording unit 182 and/or the battery 196. For example, the image recording unit 182 has a high possibility to communicate with and output the image data to an outside device like printer 12 or image processing apparatus 14, while the battery 196 has a high possibility to be charged or exchanged due to deterioration. Therefore, it becomes easy to administrate the digital camera 10 by making these elements united in the replacement unit 170 which is detachably mounted on the main unit 150.

In a different arrangement, the main unit 150 may not include the inputting unit 178 and the image reception determining unit 190, and the replacement unit 170 may include the inputting unit 178 and the image reception determining unit 190.

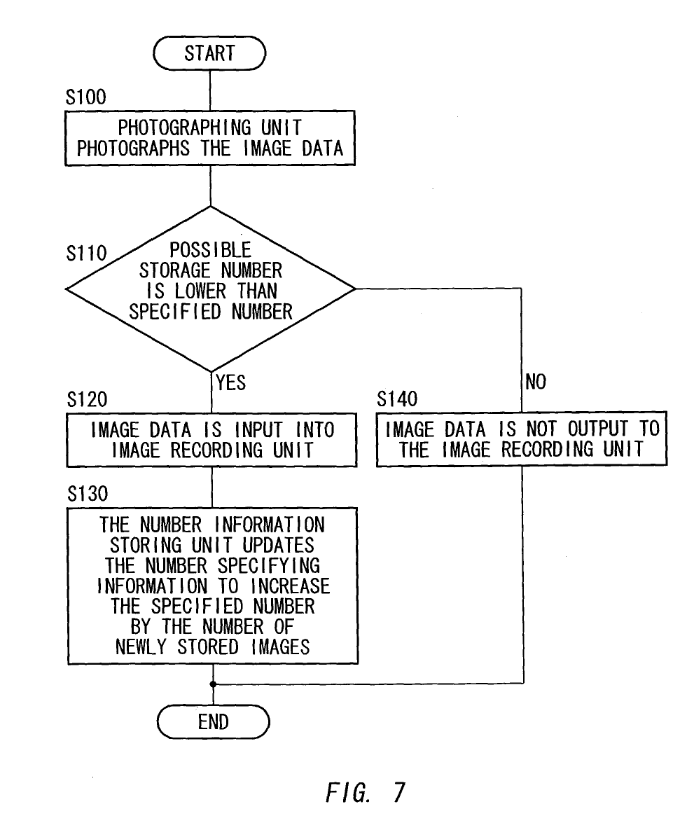

FIG. 7 is a flow chart showing a process for recording photographed image data on an image recording unit. The setting unit 174 stores the possible storage number, which indicates the number of the images that can be stored in the image recording unit 182, in advance.

First, according to an order of a user, an image is acquired by the optical unit 152, and the photographing unit 154 photographs the image data by the optical-to-electronic conversion and outputs it to the replacement unit 170 (step S100). Then, the image reception determining unit 190 compares the possible storage number stored in the setting unit 174 with the number specifying information (step S110). According to the step S110, in case the image reception determining unit 190 determines that the number specified by number specifying information is smaller than the possible storage number, the inputting unit 178 outputs the image data to the image recording unit 182 (step S120). Then, the number information storing unit 186 updates the number specifying information to increase the specified number by the number of newly stored images (step S130). According to the step S110, in case the image reception determining unit 190 determines that the number specified by the number specifying information is not smaller than the possible storage number, the inputting unit 178 does not output the image data to the image recording unit 182 (step S140).

Second Embodiment

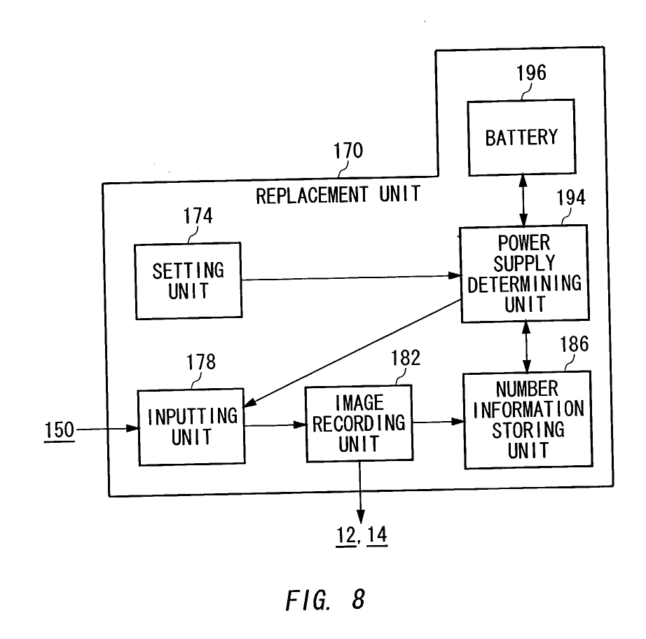

FIG. 8 shows a functional block diagram of a replacement unit 170 according to a second embodiment of the present invention. The replacement unit 170 of the present embodiment is different from that of the first embodiment in that the replacement unit 170 does not include the image reception determining unit 190 but a power supply determining unit 194. Other aspects of the second embodiment are the same with those of the first embodiment. The power supply determining unit 194 stops operation of the main unit 150 in response to the number of recorded images stored in the image recording unit 182. Functions of other units of the second embodiment are the same with those of the first embodiment. Moreover, another aspects other than the replacement unit 170 of the second embodiment are also the same with those of the first embodiment. The power supply determining unit 194 compares number specifying information stored in the number information storing unit 186 with the possible storage number stored in the setting unit 174, and doest not perform any operation in case the number specified by number specifying information is smaller than the possible storage number. That is to say, the operation of the image capturing apparatus according to the second embodiment is different from that of the first embodiment in that the inputting unit 178 outputs the image data received from the main unit 150 to the image recording unit 182. Therefore, the image recording unit 182 stores the received image data.

On the other hand, the power supply determining unit 194 compares the number specifying information stored in the number information storing unit 186 with the possible storage number, and notices the battery to stop supplying power in case the number specified by the number specifying information is not smaller than the possible storage number.

The battery 196 stops supplying power to the main unit 150 when it receives the above notice from the power supply determining unit 194. By this, the battery 196 stops the operation of the digital camera 10.

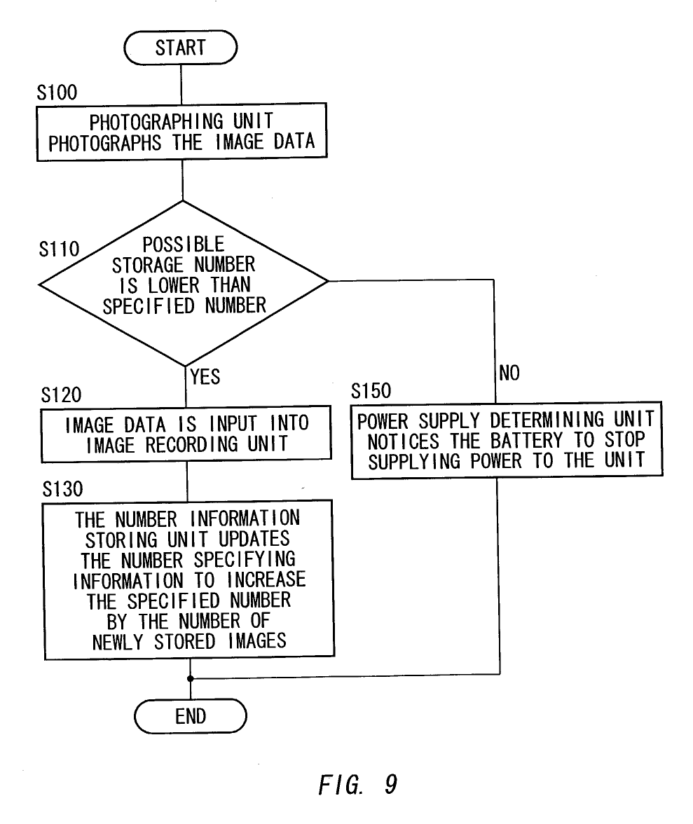

FIG. 9 is a flow chart showing a process for recording photographed image data on an image recording unit according to a second embodiment of the present invention. The setting unit 174 stores the possible storage number which indicates the number of the images which can be stored in the image recording unit 182.

First, according to an order of a user, an image is acquired by the optical unit 152, and the photographing unit 154 photographs the image data by optical-to-electronic conversion and outputs it to the replacement unit 170 (step S100). Then, the power supply determining unit 190 compares the possible storage number stored in the setting unit 174 with the number specifying information stored in the number information storing unit 186 (step S110). According to the step S110, in case the power supply determining unit 194 determines that the number specified by number specifying information is smaller than the possible storage number, the inputting unit 178 outputs the image data to the image recording unit 182 (step S120). Then, the number information storing unit 186 updates the number specifying information to increase the specified number by the number of newly stored images (step S130). According to the step S110, in case the power supply determining unit 194 determines that the number specified by number specifying information is not smaller than the possible storage number, the power supply determining unit 194 notices the battery to stop supplying power (step S140). The battery 196 stops supplying the power to the main unit 150 (step S140).

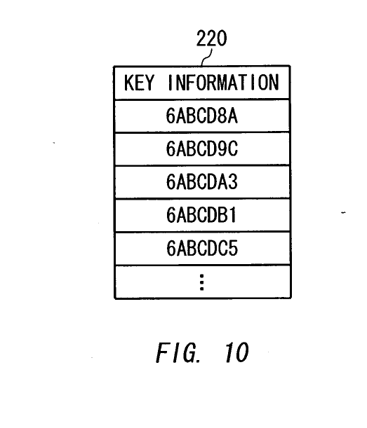

Next, a modified embodiment of the first or the second embodiment of the present invention is now described. FIG. 10 shows a modified example of information which specifies the number of images stored in the number information storing unit 186 according to the first embodiment of the present invention. Key information 220 represents an example of a group of key information according to the present invention. The number information storing unit 186 stores the key information 220 as the information specifying the number of images stored.

Each element of the key information 220 is different from other ones, and corresponds to image data of a photographed image. Therefore, each key information 220 can be used only once. The number of elements of the key information 220 is the same with the number specified by the setting unit 174. Each element of the key information 220 is structured according to a predetermined rule known to a specified person only, and therefore cannot be counterfeited by a person other than the specified person. The key information 220 is an example of information of the possible storage number set by the setting unit 174 in advance, and may be sent to the number information storing unit 186 and treated as the number specifying information.

Now, a modified example of the first embodiment is described. Referring to FIG. 6 again, the setting unit 174 sends the key information 220 to the image reception determining unit 190 as a preparatory operation before a photographing operation is performed. Then, the image reception determining unit 190 sends the received key information 220 to the number information storing unit 186. Here, each element of the key information 220 has a structure which is hard to be counterfeited and easy to find out the genuineness.

The number information storing unit 186 stores the key information 220 as number specifying information which specifies the number of images stored in the image recording unit 182. The number information storing unit 186 updates the number specifying information in response to the notification from the image recording unit 182, and deletes element(s) of the key information 220 according to the number of newly stored images. Here, the deleting operation is an example of a use-ending operation according to the present invention. By this, the number specified by the number information storing unit 186 is increased by the number of newly stored images.

The image recording unit 182 receives the image data, determines the genuineness of key information 220, and refuses to receive the image data if the key information 220 is determined to be counterfeited when the element of key information 220 is to be deleted. By doing this, it can be prohibited to store the image data in the image recording unit 182 by fraudulently acquired key information 220.

According to this modified example, the number specifying information of the number information storing unit 186 is specified by the number of deleted element of the key information 220. This is especially effective, for example, when the number of images is restricted by a contract deposit according to a lending contract. For example, if the key information 220 is hard to be counterfeited, it is difficult for an unjust user to perform photographing images over the restricted number. That is to say, the lending contract can be fulfilled easily.

Moreover, it is clear to those skilled in the art that the same modified example can also be applied to the second embodiment of the present invention.

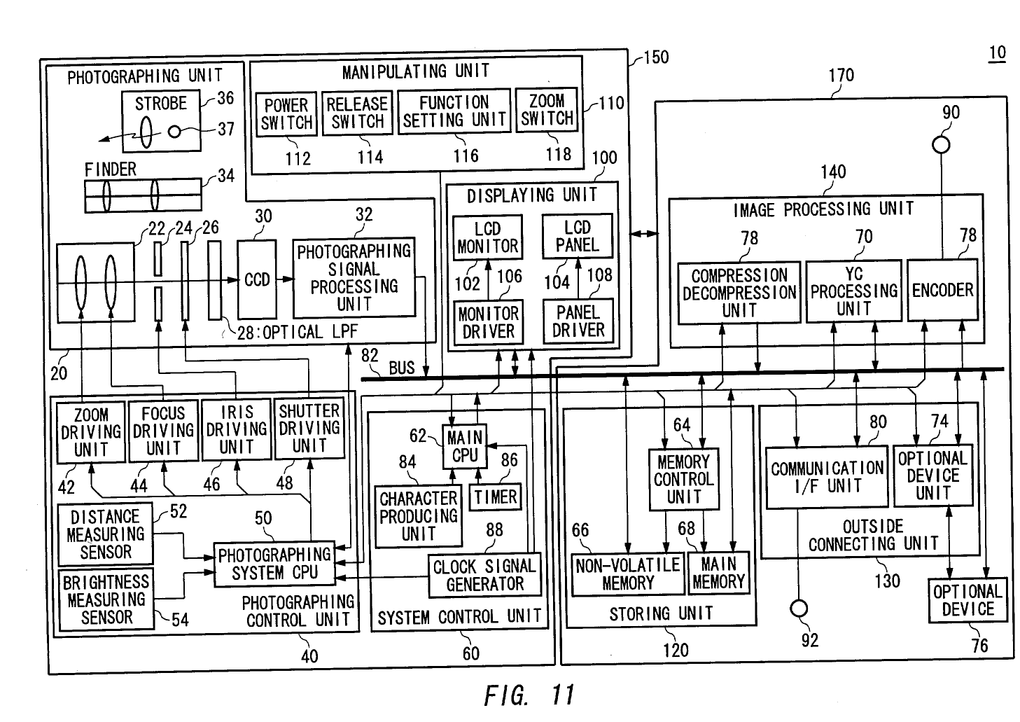

FIG. 11 shows a hardware configuration of an image capturing apparatus, e.g. a digital camera, according to an embodiment of the present invention. The digital camera 10 includes a photographing unit 20, a photographing control unit 40, a system control unit 60, a displaying unit 100, a manipulating unit 110, a storing unit 120, an outside connecting unit 130, and an image processing unit 140. The photographing unit 20 includes a photographing lens unit 22, an iris 24, a shutter 26, an optical LPF 28, a CCD 30, a photographing signal processing unit 32, a finder 34 and a strobe 36.

The photographing lens unit 22 performs a process for acquiring an object image. The photographing lens unit 22 includes a focus lens, a zoom lens or etc., and forms an object image on the surface of the CCD 30. The iris 24 concentrates light passing through the photographing lens unit 22, and the optical LPF 28 passes long-wavelength components of the light, of which wavelengths are longer than a predetermined wavelength, passing through the iris 24. Each sensor element of the CCD 30 accumulates charges (“accumulated charge”) in response to amount of light of the focused object image.

The shutter 26 is a mechanic shutter, and controls whether or not the light passing through the photographing lens unit 22 is exposed on the CCD 30. Further, the digital camera 10 has an electric shutter instead of the shutter 26. In order to embody the function of the electric shutter, a sensor element of the CCD 30 has a shutter gate and a shutter drain. By driving the shutter gate, the accumulated charges are drained to the shutter drain. By controlling the shutter gate, it is possible to control time to accumulate charges in each sensor element, namely, shutter speed. In the CCD 30, the accumulated charges are read out in turn by a shift register in response to a lead gate pulse and then a register transfer pulse as voltage signals.

The photographing signal processing unit 32 resolves the voltage signal, an analog signal, indicating the object image outputted from the CCD 30 into R, G, and B components. And, the photographing signal processing unit 32 adjusts white balance of the object image by adjusting R, B, and G components. The photographing signal processing unit 32 performs a gamma compensation of the object image. Then, the photographing signal processing unit 32 converts the analog signal, which is resolved into R, G, and B components, into digital signals, and outputs image data of the object image so acquired to the system control unit 60.

The finder 34 includes a displaying device, and various kinds of information from e.g. a main CPU 62 (described later) may be displayed on the finder 34. The strobe 36 includes a discharge tube which discharges an energy accumulated in a capacitor, and performs light emission from the discharge tube 37 when the energy is supplied to the discharge tube 37.

The photographing control unit 40 includes a zoom driving unit 42, a focus driving unit 44, an iris driving unit 46, a shutter driving unit 48, a photographing system CPU 50 for controlling them, a distance measuring sensor 52 and a brightness measuring sensor 54. Each of the zoom driving unit 42, the focus driving unit 44, the iris driving unit 46 and shutter driving unit 48 includes a driving device like a step motor, and drives each element of the photographing unit 20. When a release switch (described later) 114 is pressed, the distance measuring sensor 52 measures the distance to the object, and the brightness measuring sensor 54 measures the brightness of the object. And, the distance measuring sensor 52 and the brightness measuring sensor 54 provide the photographing system CPU 50 with data of measured distance to the object (“measured distance data”) and measured brightness of the object (“measured brightness data”).

On the basis of photographing information, such as zoom magnification, ordered by a user, the photographing system CPU 50 adjusts the zoom magnification and the focus of the photographing lens unit 22 by controlling the zoom driving unit 42 and the focus driving unit 44. Moreover, the photographing system CPU 50 adjusts the zoom magnification and the focus by controlling the zoom operation unit 42 and the focus operating unit 44 on the basis of the measured distance data received from the distance measuring sensor.

The photographing system CPU 50 decides opening value of the iris and the shutter speed on the basis of the measured brightness data received from the brightness measuring sensor. The iris driving unit 46 and the shutter driving unit 48 control the opening value of the iris 24 and the operation of the shutter 26 on the basis of the decision.

Moreover, on the basis of the measured brightness data received from the brightness measuring sensor 54, the photographing system CPU 50 controls the light emission of the strobe 36 and opening value of the iris 24. The CCD 30 starts accumulating charges when the user orders to capture an image, and outputs accumulated charges to the photographing signal processing unit 32 after a shutter time, calculated based on the measured brightness data, has passed.

The system control unit 60 includes a main CPU 62, a character producing unit 64, a timer 86 and a clock signal generator 88. The main CPU 62 controls the digital camera 10 as a whole, especially the system control unit 60. The main CPU 62 receives necessary information with the photographing system CPU 50 by e.g. serial communication.

The clock signal generator 88 generates operation clock signal, and provides it to the main CPU 62. Moreover, the clock signal generator 88 generates the operation clock signal of the photographing system CPU 50 and the displaying unit 100. The clock signal generator 88 provides the main CPU 62, the photographing system CPU and the displaying unit 100 with operation clock signals which have different frequencies, respectively.

The character producing unit 84 produces character information and/or diagram information like photographing date or title. The timer 86 is backed-up by, for example, a battery, counts time always and provides the main CPU 62 with time information like the photographing date of an image taken. It is preferable that the timer 86 counts the time by the power provided by a storage battery in case that power supply of the main body of the digital camera 10 is shut off. In addition, it is preferable that the character producing unit 84 and the timer 86 are installed on the main CPU 62.

The storing unit 120 includes a memory control unit 64, a non-volatile memory 66 and a main memory 68. The memory control unit 64 controls the non-volatile memory 66 and the main memory 68. The non-volatile memory 66 may include an electrically erasable and programmable read only memory (“EEPROM”) or a flash memory, and stores information, such as a user setting information or a maker setting information, which must be kept and maintained in case that the power supply of the digital camera 10 is shut off. The non-volatile memory 66 may store, for example, a boot program of the main CPU 62 or a system program.

It is preferable that the main memory 96 is a memory which is comparably cheap and has high capacity like DRAM. The main memory 68 functions as a frame memory storing the data outputted from the photographing unit 20, a system memory loading various kinds of programs and a work area besides those. The non-volatile memory 66 and the main memory 68 exchange data with each other via each unit around the system control unit 60 and the bus 82. The non-volatile memory 66 may further store digital image data.

The image processing unit 140 includes a YC processing unit 70, an encoder 72 and a compression and decompression processing unit 78. In addition, the outside connecting unit 130 includes an optional device control unit 74 and a communication I/F unit 80.

The YC processing part 70 performs a YC conversion on the digital image data, and produces brightness signal Y and tint difference signals (chromo signals) B-Y and R-Y. The main memory 68 stores the brightness signal and tint difference signals on the basis of the control of the memory control unit 64.

The compression and decompression processing unit 78 reads out the brightness signal and the tint difference signals in turn from the main memory 68, and compresses those. And, the optional device control unit 74 writes the compressed digital image data (“compressed data”) in a memory card, which is an example of the optional device.

The encoder 72 converts the brightness signal and the tint difference signals to video signals (NTSC or PAL signals), and outputs those to a terminal 90. In case that the video signal is produced from the compressed data recorded in the optional device 76, the compressed data is first sent to the compression and decompression unit 78 via the optional device control unit 74. Then, the data, on which the decompression process is performed by the compression and decompression processing unit 78, is converted into video signals by the encoder 72.

The optional device control unit 74 performs processes, such as producing signals required between the bus 82 and the optional device 76, logic conversion and/or voltage conversion, according to the signal specification permitted by the optional device 76 and bus specification of the bus 82. The digital camera 10 may support a standard I/O card following PCMCIA specification other than the above described memory card. In this case, the optional device control unit 74 may include a bus control LSI for PCMCIA.

The communication I/F unit 80 performs controls like a protocol conversion according to the communication specification, for example USB, RS-232c and Ethernet. The communication I/F unit 80 may output compressed data or digital image data to external devices including network via the terminal 92. The communication I/F unit 80 includes a driver IC if necessary, and communicates with the external devices via the terminal 92. The communication I/F unit 80 may receive data by independent interface with a printer, a karaoke apparatus, a game device, and the like.

The displaying unit 100 includes an LCD monitor 102, an LCD panel 104, a monitor driver 106 and a panel driver 108. The monitor driver 106 controls the LCD monitor 102. In addition, the panel driver 108 controls the LCD panel 104. The LCD monitor 102 of a size of about 2 inches, for example, is disposed on the rear surface of the camera, and displays present photographing or playing mode, a zoom magnification value in photographing or playing mode, a battery remaining amount, a mode setting screen or an image of the object. The LCD panel 104 is, for example, a small black-and-white LCD disposed on the surface of the camera, and displays image quality (FINE/NORMAL/BASIC), light emission or prohibition of light emission from the strobe, a possible number of standard image-photographing, number of pixels, information on capacity or remaining amount of the battery, etc.

The manipulating part 110 includes a power switch 112, a release switch 114, a function setting unit 116 and a zoom switch 118. The power switch 112 turns on/off the power supply of the digital camera 10 according to the order from the user. The release switch 114 has the two-step-push structure of half-push and entire-push. For example, the photographing control unit 40 implements automatic focus adjustment and automatic exposure adjustment in case that the release switch 114 is half pushed, and the photographing unit 20 captures an image of the object in case that the release switch 114 is entirely pushed.

The function setting unit 116 is, for example, a mode dial of revolving type or a cross-type key, and receives setup data like “file format”, “special effect”, “printing”, “decision/preservation”, “display switching”, etc. The zoom switch 118 receives setup data of zoom magnification of the object acquired by the photographing unit 20.

The principal operation of the above structured digital camera is described in detail. First, the power switch 112 is pressed and the power is provided to each part of the digital camera 10. The main CPU 62 determines whether the digital camera 10 is in photographing mode or playing mode by reading the state of the function setting unit 116.

In case that the digital camera is in photographing mode, the main CPU 62 monitors the half-push state of the release switch 114. When the half-push state is detected, the photographing system CPU 50 acquires the measured brightness data from the brightness measuring sensor 54 and the measured distance data from the distance measuring sensor 52. The photographing control unit 40 adjusts the focus and the opening value of the photographing unit 20 on the basis of the measured brightness date and measured distance data acquired by the photographing system CPU 50. When the adjustment is done, the LCD monitor displays characters like “stand-by” for indicating a user of that.

Then, the main CPU 62 monitors the entire-push state of the release switch 114. When the entire-push state is detected, the shutter 26 gets closed after a predetermined shutter time and the accumulated charges of the CCD30 are drained into the photographing signal processing unit 32. The digital image data which is produced by the process of the photographing signal processing unit 32 is outputted to the bus 82. The digital image data is first stored in the main memory 68, and then processed by the YC processing unit 70 and the compression and decompression processing unit 78, and finally recorded in the optional device 76 by the optional device control unit 74. The photographed image based on the digital image data is displayed on the LCD monitor 102 in frozen state for a while, so that the user can confirm the photographed image. The image-taking operation is completed as above.

On the other hand, in case that the digital camera 10 is in playing mode, the main CPU 62 reads out the photographed image from the main memory 68, the non-volatile memory 66 and/or the optional device 76, and displays it on the LCD monitor 102 of the displaying unit 100.

If the user orders “sending images in order” or “sending images in reverse order”, the main CPU 62 reads out other images stored in the main memory 68, the non-volatile memory 66 and/or the optional device 76, and displays them on the LCD monitor 102 of the displaying unit 100.

According to the first or second embodiment, the main unit 150 corresponds to the photographing unit 20, the photographing control unit 40, the manipulating unit 110, the system control unit 60, the displaying unit 100 and the image processing unit 140. In addition, the replacement unit 170 corresponds to the storing unit 120 and the outside connection unit 130. Furthermore, the digital camera 10 may not include the photographing control unit 40 and the displaying unit 100.

As it is apparent from the above description, according to the present invention, it is possible to perform a flexible sales system and increase user conveniences by unifying elements for controlling the number of photographed images and/or communicating with external devices in a unit.

Although the present invention has been described by way of exemplary embodiments, it should be understood that those skilled in the art might make many changes and substitutions without departing from the spirit and the scope of the present invention which is defined only by the appended claims.

What is claimed is:

1. An image capturing apparatus comprising:
a main unit comprising an optical unit for acquiring an image of an object, and a photographing unit for photographing said image acquired by said optical unit as image data by optical-to-electronic conversion; and
a replacement unit comprising an image recording unit for storing said image data photographed by said photographing unit, and a number information storing unit for storing information specifying a number of images stored in said image recording unit, said replacement unit being detachably mounted on said main unit.

2. An image capturing apparatus as claimed in claim 1, wherein said replacement unit forms a portion of external housing of said photographing apparatus.

3. An image capturing apparatus as claimed in claim 1, wherein said replacement unit further comprises a battery for driving said main unit.

4. An image capturing apparatus as claimed in claim 1, wherein said replacement unit further comprises an outputting unit for outputting said stored image data.

5. An image capturing apparatus as claimed in claim 1, wherein said replacement unit further comprises a convex or concave portion in order for a user to grasp said photographing apparatus easily.

6. An image capturing apparatus as claimed in claim 1, wherein said photographing apparatus further comprises:
a setting unit for storing a predetermined possible storage number in a range of one (1) to a number of storable images determined by a capacity of said image recording unit; and
an image reception determining unit for refusing to store said image data in said image recording unit in case that a number specified by number specifying information stored in said number information storing unit is not smaller than said possible storage number stored in said setting unit, and permitting to store said image data in said image recording unit in case that said specified number is smaller than said possible storage number.

7. An image capturing apparatus as claimed in claim 6, wherein said number information storing unit stores key information of which the number is the same with said possible storage number, and changes said key information into a format indicating use-ending whenever said photographing unit outputs said image data to said image recording unit.

8. An image capturing apparatus as claimed in claim 1 further comprising:
a battery for driving said main unit;
a setting unit for storing a predetermined possible storage number in a range of one (1) to a number of storable images determined by a capacity of said image recording unit; and
a power supply determining unit for stopping supplying power from said battery in case a number specified by number specifying information stored in said number information storing unit is not smaller than said possible storage number.

9. An image capturing apparatus as claimed in claim 7, wherein said battery, said setting unit and said power supply determining unit are provided in said replacement unit.

10. A replacement unit for an image capturing apparatus, which is detachably mounted on a main unit comprising an optical unit for acquiring an image of an object and a photographing unit for photographing said image acquired by said optical unit as image data by optical-to-electronic conversion, the replacement unit comprising:
an image recording unit for storing said image data photographed by said photographing unit;
a number information storing unit for storing information specifying a number of images stored in said image recording unit; and
a battery for driving said main unit.

11. A replacement unit of an image capturing apparatus as claimed in claim 10, further comprising an outputting unit for outputting said stored image data.

12. A replacement unit of an image capturing apparatus as claimed in claim 10, further comprising a convex or concave portion in order for a user to grasp said photographing apparatus easily.

13. A replacement unit of an image capturing apparatus as claimed in claim 10 further comprising:
a setting unit for storing a predetermined possible storage number in a range of one (1) to a number of storable images determined by a capacity of said image recording unit; and
an image reception determining unit for refusing to store said image data in said image recording unit in case that a number specified by number specifying information stored in said number information storing unit is not smaller than said possible storage number stored in said setting unit, and permitting to store said image data in said image recording unit in case that said specified number is smaller than said possible storage number.

14. A replacement unit of an image capturing apparatus as claimed in claim 13, wherein said number information storing unit stores key information of which the number is the same with said possible storage number, and changes said key information into a format indicating use-ending whenever said photographing unit outputs said image data to said image recording unit.

15. A replacement unit of an image capturing apparatus as claimed in claim 10, further comprising:
a setting unit for storing a predetermined possible storage number in a range of one (1) to a number of storable images determined by a capacity of said image recording unit; and
a power supply determining unit for stopping supplying power from said battery in case a number specified by number specifying information stored in said number information storing unit is not smaller than said possible storage number.
